(19) United States
(12) Patent Application Publication
(10) Pub. No.: US 2009/0070333 A1
(43) Pub. Date: Mar. 12, 2009

(54) Method for Document Management Across Multiple Software Applications

(76) Inventor: Andrew G. Bailey, Harvest, AL (US)

Correspondence Address: BRADLEY ARANT BOULT CUMMINGS LLP, 200 CLINTON AVE. WEST, SUITE 900, HUNTSVILLE, AL, 35801, US

(21) Appl. No.: 11/854,530

(22) Filed: Sep. 12, 2007

(51) Int. Cl. G06F 17/30

(52) U.S. Cl. 707/9; 707/E17.008

(57) ABSTRACT

A method for accessing data stored electronically in a computer system by a database software application has been developed. The method includes attaching a retrieving user interface to a primary software application that is currently being used by a user of the computer system. Next a data field is selected in the primary software application that contains specific subject data based on the user's activity m the primary software application. The subject data is determined in the data field with a pattern matching algorithm. Finally, a connected field is established between the primary software application and a secondary document management application, where the connected field is based on a pattern match in the primary software application and references related files of documents for access by the user in the secondary document management application.

### FIELD OF THE INVENTION

The invention relates generally to computer software. More specifically, the present invention relates generally to a method for electronic document management across multiple software platforms.

### BACKGROUND ART

There are many separate software applications that a user may have access to from their desktop computer. Typically these are applications that manipulate/store data in a database. It is not uncommon to use different software applications from different sources that are incompatible with each other. For example, one application may be used as contact management or customer relationship management (“CRM”) software application to maintain information about clients while a separate document management application is used to maintain any documents associated with clients. A problem arises when the user is viewing a client record in the contact management application and then wants to view the documents associated with that client. The user has to switch from the contact management application to the document management application and then lookup the client's information to view these documents. Consequently, it is clear that a method of document management across different software applications is needed.

### SUMMARY OF THE INVENTION

In some aspects, the invention relates to a method for accessing data stored electronically m a computer system by a database software application, comprising: attaching a retrieving user interface to a primary software application that is currently being used by a user of the computer system; selecting a data field in the primary software application that contains specific subject data based on the user's activity in the primary software application; determining the specific subject data in the data field with a pattern matching algorithm; and establishing a connected field between the primary software application and a secondary document management application, where the connected field is based on a pattern match in the primary software application and references related files of documents for access by the user in the secondary document management application.

In other aspects, the invention relates to a method for accessing data stored electronically in a computer system by a database software application, comprising: step for attaching a retrieving user interface to a primary software application that is currently being used by a user of the computer system; step for selecting a data field in the primary software application that contains specific subject data based on the user's activity in the primary software application; step for determining the specific subject data in the data field with a pattern matching algorithm; step for verifying a user's authorization to access related documents in the secondary document management application; and step for establishing a connected field between the primary software application and a secondary document management application, where the connected field is based on a pattern match in the primary software application and references related files of documents for access by the user in the secondary document management application.

Other aspects and advantages of the invention will be apparent from the following description and the appended claims.

### BRIEF DESCRIPTION OF DRAWINGS

It should be noted that identical features in different drawings are shown with the same reference numeral.

FIG. 1 shows a diagram of a typical business setup using database applications and a document management system.

FIG. 2 shows an example of a retrieving user interface (RUI) in non-expanded mode that is attached to a third party customer relationship management (CRM) application.

FIG. 3 shows an example of the RUI shown in FIG. 2 in expanded mode.

FIG. 4 shows an example of the RUI shown in FIG. 3 with the relevant document list displayed.

FIG. 5 shows a flow chart for the setup procedures for a retriever application in one example of the present invention.

FIG. 6 shows a flow chart for the operating procedures for a retriever application in one example of the present invention.

### DETAILED DESCRIPTION

The present invention relates to document management systems being integrated with external software applications to allow a standard lookup mechanism for documents without regard to the database definition of the targeted external software application.

Generally a company will use a database application(s) as the primary method of managing the business' computer related applications. Most companies will use multiple electronic storage areas for these databases. For example, one or more applications are database applications that contain information about a client/process/project. Other databases are used for a set of documents associated with that client/process/project (e.g., a document management system). This would include scanned documents and electronic documents generated internally and externally.

For these applications, documents may be segregated by client name, with various sub-folders. For example, for an accounting document management system, sub-folders may include: basic accounting information; bookkeeping data; correspondence; investments; K-1 forms; miscellaneous reports; tax forms; and year end information. For a medical office document management system, sub-folders may include: medical history; lab work; transcriptions; and correspondence. The larger a business, the more likely it is that multiple database applications are used to maintain information. It is common that these different database applications are provided by different computer software developers and as a result, the applications are not compatible working with each other.

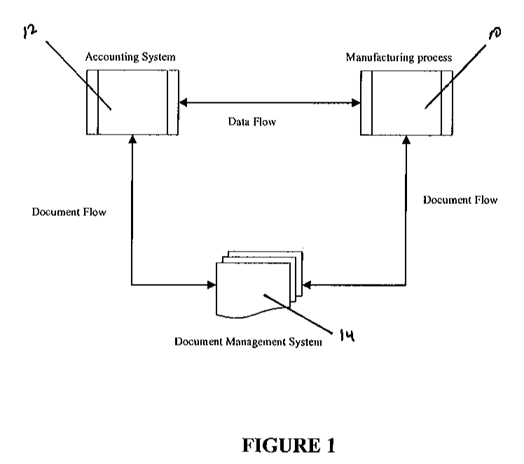

FIG. 1 shows a diagram of an example of one such organization. In this example, a manufacturing company has a database application to control the manufacturing process 10 and a separate accounting system 12 to manage financials. Both of these existing systems contain some of the same data and possibly share the data. A document management system 14 stores documents for both the manufacturing process and the accounting system. Documents are entered for both systems through the document management system.

Another example of a use of the present invention would be a medical office that uses a practice management database application to track patient data. Such an organization typically also maintains a separate document management application to store the medical documents (transcriptions, lab work, medical history, etc.) associated with each patient. The present invention could be used by medical personnel to instantly retrieve these documents when viewing patient data in the practice management application.

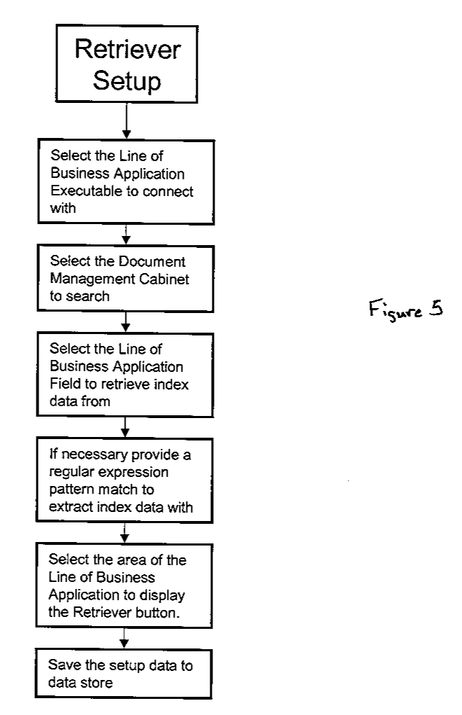

The present invention includes a system, method and user interface for standardizing access to the set of documents associated with the client/process/project described above without regard to the type of database application that stores the client/process/project data. The present system and method is generally usable with any Windows® based application that has a field that can be text associated with a second application (e.g., a document management application). A “retrieving user interface” (RUI) is attached to a primary software application by a manual selection process by the user. The RUI is the user interface for the “retriever” application. It is attached to the primary software application during the setup procedures. FIG. 5 shows a flow chart for the setup procedures for a retriever application in one example of the present invention. In some embodiments, the RUI automatically opens and remains attached to the primary application until it is dismissed by the user. However, in other embodiments, the retriever application must be manually opened by the user once the primary application is opened.

A data field in the primary application is selected for a lookup system which is a call from the RUI to a secondary database application such as a document management system. The lookup system uses the data from the field to determine which set of documents the user needs to access in a secondary database. Examples of data fields may include: names, ID numbers, social security numbers, etc. The specific data field may be manually selected by the user.

An offset is determined for the selected field. The offset acts as a filter to the data field by identifying the relevant data in the data field. For example, if a client's name is included the field that also includes other data, the offset will be able to extract the name from the data field. This is done by determining a “regular expression pattern match” with pattern matching techniques that are known in the art. Once the offset is established, the field is now called a “connected field”. As the user processes information through the primary database application, the lookup system keeps tracks and stores data fields that Indicate which file folders in the document management system containing relevant documents the user may need to access. The pattern matches for a data field are stored until the user moves on to another pattern match. In this way, a user can open documents associated with the current client/process/project data without having to start up the secondary application or transition away from the primary database application. This results in significant gains in productivity as the associated documents are always available and ready for viewing.

In some embodiments of the invention, the document management system maintains secure access to the appropriate documents based on the user login to the RUI itself. RUI users will only be able to access documents that they have rights to access. The document management system will typically have a security rights manager which is used to manage which users are allowed to see which documents. This security rights manager of the document management system will be used by the RUI to determine if the user is authorized to access a specific document. This security may be applied at the cabinet folder and document levels. Also, an audit trail may also be used in the document management system to track all activities for a document.

In other embodiments, the present invention allows the RUI to be attached to multiple secondary database applications resulting in a single standard interface to document storage. The system is tied directly to the database application and is automatically available when the user is accessing the primary database application. If the user is not currently using the primary database application, then the RUI is not displayed and the user is unaware it is running. This embodiment allows a business to maintain, two or more separate storage areas, yet connect them when it is most convenient to the user.

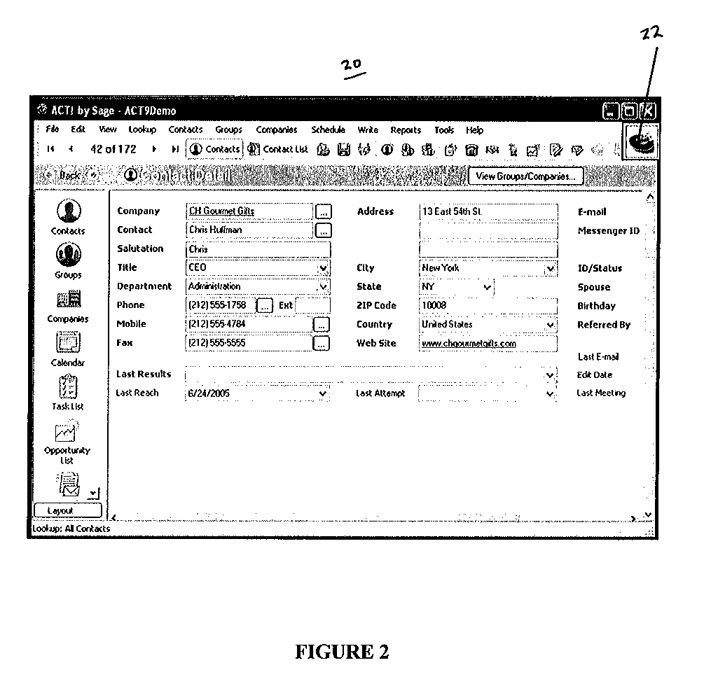

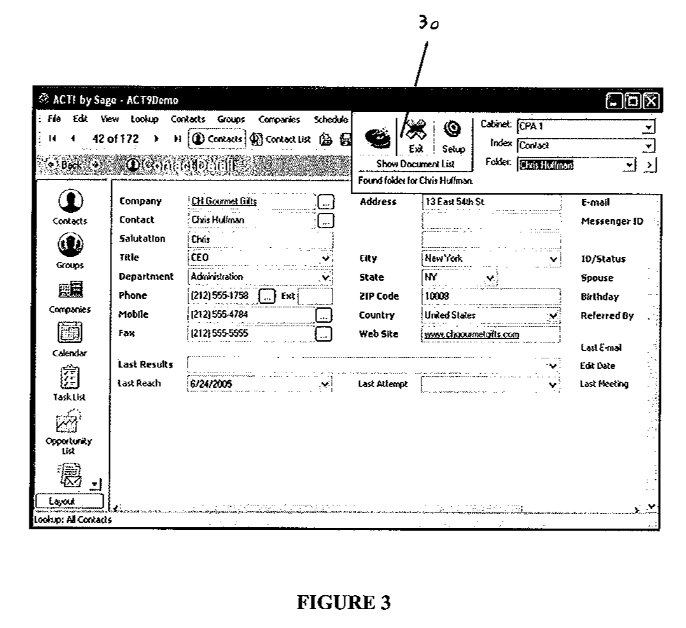

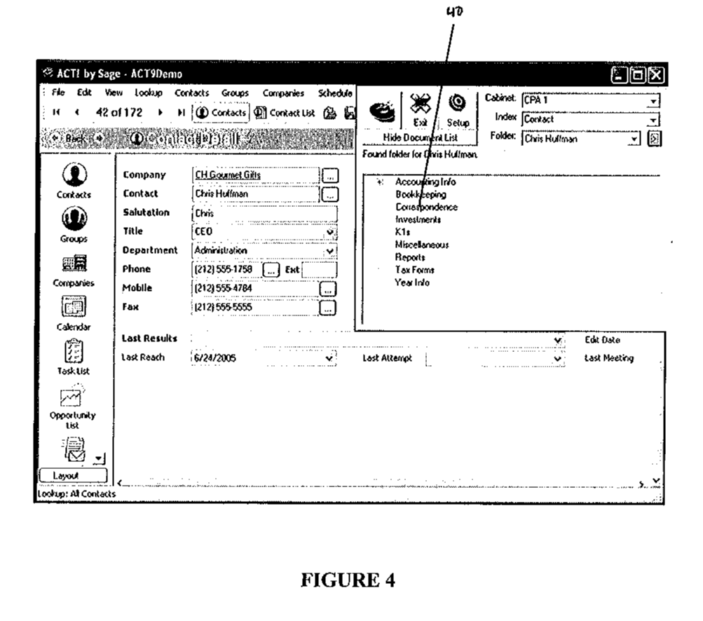

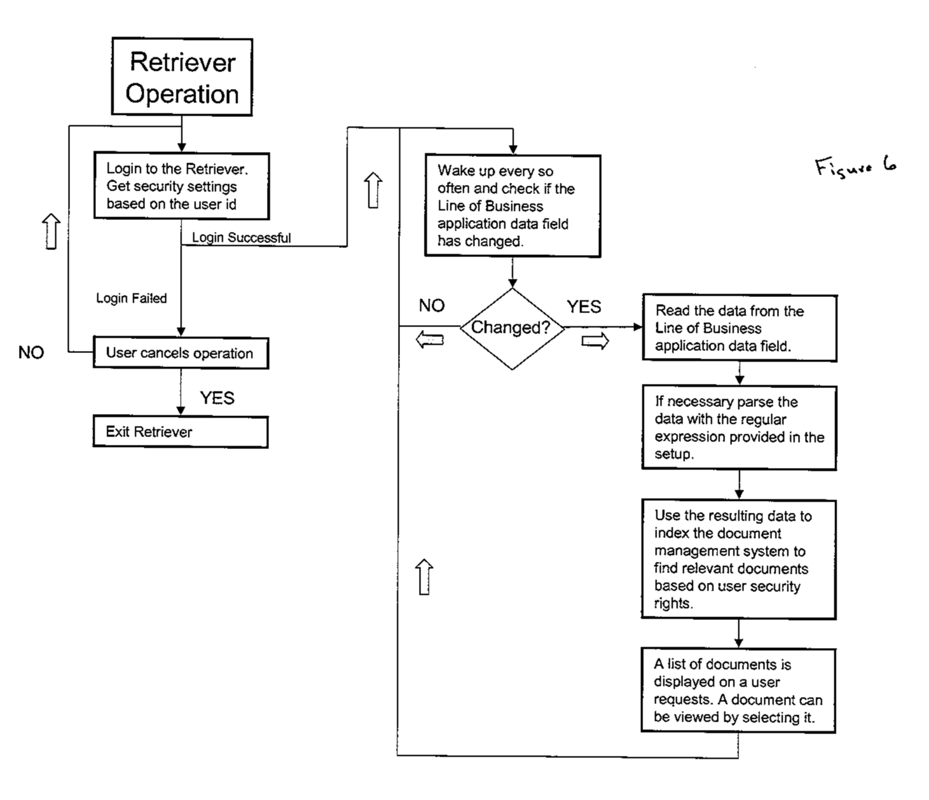

FIG. 2 shows an example of an RUI (in a non-expanded mode and located in the upper right hand corner of the GUI) 22 attached to a common third party CRM application 20 as a primary application. As depicted in FIG. 2, the CRM application may list basic contact information by company, contact name, title, phone number, address, and web-site address. In this example, the RUI is attached to the Contact field in the third-party database application. In other embodiments, the RUI could be attached to other data fields such as the company name, address, or phone number. As the primary application is moved to other contacts, the RUI system moves with it and is “attached” to the secondary database application. FIG. 3 shows the same RUI in an expanded mode 30. In the expanded mode, the RUI informs the user that it has found the appropriate folder. The user simply has to click the “Show Document List” button and a list of documents residing in the secondary database will be displayed. FIG. 4 shows the RUI in expanded mode with the relevant document list 40 displayed for the user. FIG. 6 shows a flow chart for the operating procedures for a retriever application in one example of the present invention.

The located documents can be directly opened using the RUI. Full access to the appropriate folder in the document management system is also available so that documents can be added to the document management system once located via the RUI. The disclosed system and method allows a standard lookup mechanism for documents without regard to the database definition of the targeted primary application. The integration between the primary application and the secondary application does not require any special API, SDK or PLL code in the primary application. As discussed above, the system and method may also be used to integrate medical office practice management applications with patient data records. In this example, the primary application would be the medical office practice management application and would likely include information about a patient's name, record number, and contact information. The secondary application database could be the medical documents related to that patient (i.e., transcriptions, lab work, medical history, etc.). The data field selected for lookup in this embodiment would likely be the patient name.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. A method for accessing data stored electronically in a computer system by a database software application, comprising:
attaching a retrieving user interface to a primary software application that is currently being used by a user of the computer system;
selecting a data field in the primary software application that contains specific subject data based on the user's activity in the primary software application;
determining the specific subject data in the data field with a pattern matching algorithm; and
establishing a connected field between the primary software application and a secondary document management application, where the connected field is based on a pattern match in the primary software application and references related files of documents for access by the user in the secondary document management application.

2. The method of claim 1, further comprising:
verifying a user's authorization to access related documents in the secondary document management application with the retrieving user interface.

3. The method of claim 2, where the user's authorization is maintained by the secondary document management application.

4. The method of claim 1, further comprising:
storing the data fields for later reference by the user.

5. The method of claim 1, further comprising:
storing a list of the related documents in the secondary document management application that were accessed by the user.

6. The method of claim 1, where the connected field references related file folders in the secondary document management application.

7. The method of claim 1, where the connected field is established between the primary software application and multiple secondary document management applications.

8. A method for accessing data stored electronically in a computer system by a database software application, comprising:
step for attaching a retrieving user interface to a primary software application that is currently being used by a user of the computer system;
step for selecting a data field in the primary software application that contains specific subject data based on the user's activity in the primary software application;
step for determining the specific subject data in the data field with a pattern matching algorithm;
step for verifying a user's authorization to access related documents in the secondary document management application; and
step for establishing a connected field between the primary software application and a secondary document management application, where the connected field is based on a pattern match in the primary software application and references related files of documents for access by the user in the secondary document management application.
